(19) United States
(12) Patent Application Publication
(10) Pub. No.: US 2026/0164486 A1
(43) Pub. Date: Jun. 11, 2026

(54) METHOD AND APPARATUS FOR MANAGING BACKHAUL INFORMATION-BASED SESSION IN WIRELESS COMMUNICATION SYSTEM

(71) Applicant: SAMSUNG ELECTRONICS CO., LTD., Suwon-si, Gyeonggi-do (KR)

(72) Inventor: Dongyeon KIM, Suwon-si (KR)

(21) Appl. No.: 19/127,051

(22) PCT Filed: Nov. 2, 2023
(86) PCT No.: PCT/KR2023/017404

§ 371 Date: May 2, 2025

(30) Foreign Application Priority Data
Nov. 3, 2022 (KR) 10-2022-0145150

(51) Int. Cl. H04W 76/15; H04W 28/02; H04W 84/06

(52) U.S. Cl. CPC H04W 76/15; H04W 28/0268; H04W 84/06

(57) ABSTRACT

The present disclosure relates to a 5G or 6G communication system for supporting higher data transmission rates. A method performed by an access and mobility management function (AMF) entity in a wireless communication system comprises receiving, from a base station, a request regarding establishment of a protocol data unit (PDU) session, in case that two or more backhaul networks are used for the PDU session, transmitting, to a session management function (SMF) entity, a PDU session establishment request comprising first information on a satellite backhaul category and second information indicating that the two or more backhaul networks are used, receiving, from the SMF entity, quality of service (QoS) information of a plurality of backhaul networks for determining a first backhaul network to be used in a user plane, among the two or more backhaul networks, based on the first information and the second information, transmitting, to the base station, the QoS information, receiving, from the base station, information indicating a first category of the first backhaul network among the plurality of backhaul networks, based on the QoS information and transmitting, to the SMF entity, information indicating the first category.

### TECHNICAL FIELD

The disclosure relates to a method and an apparatus for backhaul information-based session management in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mm Wave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Provided according to an embodiment of the disclosure are an apparatus and a method capable of effectively providing services in a mobile communication system.

### Solution to Problem

According to an embodiment, a method performed by an access and mobility management function (AMF) entity in a wireless communication system may include: receiving a request regarding establishment of a protocol data unit (PDU) session from a base station; in case that two or more backhaul networks are used for the PDU session, transmitting a PDU session establishment request including first information on a satellite backhaul category and second information indicating that the two or more backhaul networks are used, to a session management function (SMF) entity; receiving quality of service (QoS) information of a plurality of backhaul networks for determining a first backhaul network to be used in a user plane, among the two or more backhaul networks, based on the first information and the second information, from the SMF entity; transmitting the QoS information to the base station; receiving information indicating a first category of the first backhaul network, among the plurality of backhaul networks, based on the QoS information, from the base station; and transmitting information indicating the first category to the SMF entity.

According to an embodiment, an access and mobility management function (AMF) entity in a wireless communication system may include a transceiver and a controller coupled to the transceiver. The controller may be configured to: receive a request regarding establishment of a protocol data unit (PDU) session from a base station; in case that two or more backhaul networks are used for the PDU session, transmit a PDU session establishment request including first information on a satellite backhaul category and second information indicating that the two or more backhaul networks are used, to a session management function (SMF) entity; receive quality of service (QoS) information of a plurality of backhaul networks for determining a first backhaul network to be used in a user plane, among the two or more backhaul networks, based on the first information and the second information, from the SMF entity: transmit the QoS information to the base station; receive information indicating a first category of the first backhaul network, among the plurality of backhaul networks, based on the QoS information, from the base station; and transmit information indicating the first category to the SMF entity.

According to an embodiment, a method performed by a session management function (SMF) entity in a wireless communication system may include: in case that two or more backhaul networks are used for a protocol data unit (PDU) session, receiving a PDU session establishment request including first information on a satellite backhaul category and second information indicating that the two or more backhaul networks are used, from an access and mobility management function (AMF) entity; transmitting a session management (SM) policy request including the first information and the second information to a policy control function (PCF) entity; receiving quality of service (QoS) information of a plurality of backhaul networks for determining a first backhaul network to be used in a user plane, among the two or more backhaul networks, based on the first information and the second information, from the PCF entity; transmitting the QoS information of the plurality of backhaul networks to the AMF entity; and receiving information indicating a first category of the first backhaul network, among the plurality of backhaul networks, based on the QoS information, from the AMF entity.

According to an embodiment, a session management function (SMF) entity in a wireless communication system may include a transceiver and a controller coupled to the transceiver. The controller may be configured to: in case that two or more backhaul networks are used for a protocol data unit (PDU) session, receive a PDU session establishment request including first information on a satellite backhaul category and second information indicating that the two or more backhaul networks are used, from an access and mobility management function (AMF) entity; transmit a session management (SM) policy request including the first information and the second information to a policy control function (PCF) entity; receive quality of service (QoS) information of a plurality of backhaul networks for determining a first backhaul network to be used in a user plane, among the two or more backhaul networks, based on the first information and the second information, from the PCF entity; transmit the QoS information of the plurality of backhaul networks to the AMF entity; and receive information indicating a first category of the first backhaul network, among the plurality of backhaul networks, based on the QoS information, from the AMF entity.

### Advantageous Effects of Invention

An embodiment of the disclosure can provide an apparatus and a method capable of effectively providing services in a wireless communication system.

Advantageous effects obtainable from the disclosure may not be limited to the above-mentioned effects, and other effects which are not mentioned may be clearly understood from the following descriptions by those skilled in the art to which the disclosure pertains.

### BRIEF DESCRIPTION OF DRAWINGS

FIG. 1 illustrates a 5G system structure of the disclosure.

FIG. 2 illustrates a 5G system structure in case that one or more backhaul network connections are possible between one radio access network (RAN) and one 5G core network according to an embodiment of the disclosure.

FIG. 3 illustrates a procedure of establishing a protocol data unit (PDU) session in a 5G system in case that one or more backhaul network connections are possible between one RAN and one 5G core network according to an embodiment of the disclosure.

FIG. 4 illustrates a procedure of establishing a PDU session in a 5G system in case that one or more backhaul network connections are possible between one RAN and one 5G core network according to an embodiment of the disclosure.

FIG. 5 illustrates an example of a functional structure of a UE according to an embodiment of the disclosure.

FIG. 6 illustrates an example of a functional structure of a core network entity according to an embodiment of the disclosure.

### MODE FOR THE INVENTION

Hereinafter, the operation principle of the disclosure will be described in detail with reference to the accompanying drawings.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The embodiments of the disclosure are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in the 3rd generation partnership project long term evolution (3GPP LTE) and 3GPP 5G standards will be used for the sake of descriptive convenience. However, the disclosure is not limited by these terms and names, and may be applied in the same way to systems that conform other standards.

Hereinafter, exemplary embodiments of the disclosure will be described in detail with reference to the accompanying drawings. It should be noted that, in the accompanying drawings, the same or like elements are designated by the same or like reference signs as much as possible. Also, it should be noted that the following accompanying drawings of the disclosure are provided to help an understanding of the disclosure and the disclosure is not limited to configurations or arrangements illustrated in the drawings of the disclosure.

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a “beyond 4G network” communication system or a “post long term evolution (post LTE)” system.

The 5G communication system is considered to be implemented in ultrahigh frequency (mmWave) bands, (e.g., 60 GHz bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (CoMPs), reception-end interference cancellation, and the like.

In the 5G system, hybrid FSK and QAM modulation (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The 5G system is considering supports for more various services as compared to the conventional 4G system. For example, the most representative service may include a ultrawide band mobile communication service (enhanced mobile broad band (eMBB)), an ultrahigh reliable/low latency communication service (ultra-reliable and low latency communication (URLLC)), a massive device-to-device communication service (massive machine type communication (mMTC)), and a next-generation broadcast service (evolved multimedia broadcast/multicast service (eMBMS)). A system providing the URLLC service may be referred to as a URLLC system, and a system providing the eMBB service may be referred to as an eMBB system. The terms “service” and “system” may be interchangeably used.

Among these services, the URLLC service is a service that is newly considered in the 5G system, in contrast to the existing 4G system, and requires to meet ultrahigh reliability (e.g., packet error rate of about 10-5) and low latency (e.g., about 0.5 msec) conditions as compared to the other services. To meet these strict conditions required therefor, the URLLC service may need to apply a shorter transmission time interval (TTI) than the eMBB service, and various operating schemes employing the same are now under consideration.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to IoT networks. For example, technologies such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology.

Highly developed satellite communication technologies have been followed by efforts to integrate satellite communication technologies which have been introduced only in a limited manner with mobile communication networks. Particularly, according to the 3^{rd} generation partnership project (3GPP), there has been ongoing research to introduce a satellite link in a backhaul section which is conventionally connected by an optical fiber-based wired link (the section between a radio access network (RAN) and a core network).

According to the 3^{rd} generation partnership project (3GPP), there has been ongoing standardization regarding various scenarios for combining mobile communication and 5G technologies in 5^{th} generation (5G) communication systems. Particularly, there has been ongoing standardization regarding a scheme for introducing a satellite connection in a backhaul section which connects a radio access network (RAN) and a core network. The satellite connection has various advantages such as reduced costs for configuring wired links (buried optical fiber cable installation and the like). Meanwhile, application of satellite technology to the backhaul section may result in a variable network situation, a high latency, or other phenomena, and an additional mechanism may be necessary to satisfy the quality of service (QoS) in 5G systems.

Application of satellite technology to the backhaul section may result in a high latency than when a terrestrial backhaul network is used, in connection with transmitting control signals and user data through a terrestrially installed RANs and/or core networks. Such a high latency may require modifications regarding session management methods, including selection of a network function (NF) for session management, selection of a QoS profile for policy and charging management, and the like.

Therefore, there may be a need for a technology wherein, in case that a non-terrestrial backhaul network including satellites has been used, or in case that a high latency may occur in the backhaul section due to other backhaul network characteristics, backhaul network-related information is configured in advance when configuring a RAN and a core network such that a modification procedure necessary for session management may be be initiated at the timepoint of use of a backhaul network in which a high latency actually occurs.

The technical subjects pursued in the disclosure may not be limited to the above-mentioned technical subjects, and other technical subjects which are not mentioned may be clearly understood from the following descriptions by those skilled in the art to which the disclosure pertains.

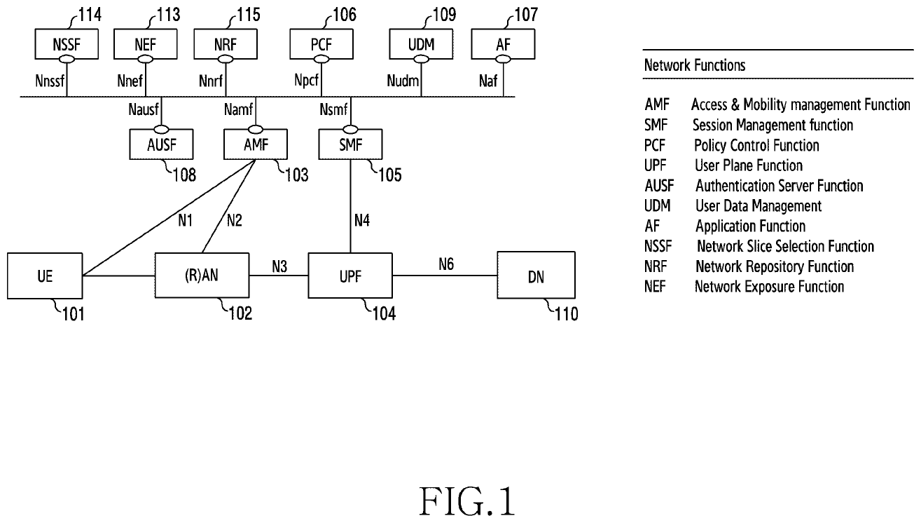

FIG. 1 illustrates a 5G system structure of the disclosure.

Network entities included in the network structure of the 5G system in FIG. 1 may include network functions (NFs) according to system implementation.

Referring to FIG. 1, the network structure of the 5G system 100 according to an embodiment may include various network entities. For example, the 5G system 100 may include an authentication server function (AUSF) 108, a (core) access and mobility management function (AMF) 103, a session management function (SMF) 105, a policy control function (PCF) 106, an application function (AF) 107, unified data management (UDM) 109, a data network (DN) 110, a network exposure function (NEF) 113, a network slicing selection function (NSSF) 114, an edge application service domain repository (EDR) 113, an edge application server (EAS) (not illustrated), an EAS discovery function (EASDF) (not illustrated), a network data analytics function (NWDAF) (not illustrated), a user plane function (UPF) 104, a (radio) access network ((R)AN) 102, and user equipment (UE) 101.

According to an embodiment, respective NFs of the 5G system 100 may support the following functions:

The ASUF 108 may process and store data for authentication of the UE 101.

The AMF 103 may provide functions for UE-level access and mobility management, and one UE may be basically connected to one AMF. Specifically, the AMF 103 may support functions such as signaling between CN nodes for mobility between 3GPP access networks, termination of a radio access network (RAN) control plane (CP) interface (that is, N2 interface), termination (N1) of non-access stratum (NAS) signaling, NAS signaling security (NAS ciphering and integrity protection), AS security control, registration management (registration area management), connection management, idle mode UE reachability (including controlling and performing paging retransmission), mobility management control (subscription and policy), inter-system mobility and inter-system mobility support, network slicing support, SMF selection, lawful intercept (regarding AMF events and L1 system-related interfaces), transferring/providing messages for session management (SM) between the UE and SMF, transparent proxy for SM message routing, access authentication, access authorization including roaming right checkup, transferring/providing SM messages between the UE and SMF, security anchor function (SAF), and/or security context management (SCM). Some or all functions of the AMF 103 may be supported in a single instance of one AMF.

The DN 110 may be referred to, for example, as an operator service, Internet access, a 3^{rd} party service, or the like. The DN 110 may transmit a downlink protocol data unit (PDU) to the UPF 104, or may receive a PDU transmitted from the UE 101 from the UPF 104.

The PCF 106 may receive information on packet flows from an application server and may provide functions of determining policies such as mobility management, session management, and the like. For example, the PCF 106 may support a unified policy framework for controlling network operations, may provide policy rules such that control plane function(s) (for example, AMF, SMF, and the like) may enact policy rules, may implement a front end for accessing relevant subscription information in order to determine policies in a user data repository (UDR), and may support other functions.

The SMF 105 may provide session management functions. In case that the UE has multiple sessions, respective sessions may be managed by different SMFs 105. For example, the SMF 105 may support functions such as session management (for example, establishing, modifying, and releasing sessions, including maintaining a tunnel between the UPF 104 and the (R)AN 102 nodes), UE IP address allocation and management (including selective authentication), UP function selection and control, configuring traffic steering for routing traffic from the UPF 104 to an appropriate destination, termination of an interface toward policy control functions, enacting the control part of quality of service (QoS) and policies, lawful intercept (regarding SM events and L1 system-related interfaces), termination of SM parts of NAS messages, downlink data notification, AN specific SM information's initiator (transferring the same to the (R)AN 102 via the AMF 103 and through N2), determining SSC modes of sessions, and roaming functions. Some or all functions of the SMF 105 may be supported in a single instance of one SMF.

The UDM 109 may store the user's subscription data, policy data, and the like. The UDM 109 may include two parts, that is, an application front end (FE) (not illustrated) and a user data repository (UDR) (not illustrated).

The FE may include a UDM FE configured to handle position management, subscription management, credential processing, and the like, and a PCF configured to handle policy control. The UDR may store data requested for functions provided by the UDM-FE, and policy profiles requested by the PCF. Data stored in the UDR may include policy data and user subscription data including subscription identifiers, security credentials, subscription data related to access and mobility, and session-related subscription data. The UDM-FE may support functions such as accessing subscription information stored in the UDR, authentication credential processing, user identification handling, access authentication, registration/mobility management, subscription management, and/or SMS management.

The UPF 104 may transfer a downlink PDU received from the DN 110 to the UE 101 via the (R)AN 102. The UPF 104 transfers an uplink PDU received from the UE 101 via the (R)AN 102 to the DN 110. For example, the UPF 104 may support the following functions: an anchor point for intra/inter-radio access technology (RAT) mobility; an external PDU session point of interconnect to a data network; packet routing and forwarding; a user plane part of packet inspection and policy rule enactment; lawful intercept; traffic usage reporting; an uplink classifier for supporting routing of traffic flows to the data network; a branching point for supporting a multi-homed PDU session; QoS handling for the user plane (for example, packet filtering, gating, uplink/downlink rate enactment); uplink traffic verification (SDF mapping between a service data flow (SDF) and a QoS flow); marking transport level packets in the uplink and downlink; downlink packet buffering; and/or downlink data notification triggering. Some or all functions of the UPF 104 may be supported in a single instance of one UPF.

The AF 107 interworks with the 3GPP core network to provide services. For example, the AF 107 may interwork with the 3GPP core network to support functions such as affecting applications on traffic routing, accessing network capability exposure, and/or interworking with the policy framework for policy control.

The (R)AN 102 refers to a new radio access network supporting both evolved E-UTRA (E-UTRA) which is an evolved version of 4G radio access technology, and new radio (NR) access technology (for example, gNB), as a whole.

The gNB may support functions for radio resource management. For example, the gNB may support the following functions: radio bearer control; radio admission control; connection mobility control; dynamic allocation of resources (that is, scheduling) to the UE in the uplink/downlink; Internet protocol (IP) header compression; user data stream encryption; and/or integrity protection. For example, in case that routing to the AMF is not determined based on information provided to the UE, the gNB may support the following functions: selecting the AMF during the UE's attachment; routing user plane data to UPF(s); routing control plane information to the AMF; connection setup and release; paging message scheduling and transmission (generated from the AMF); system broadcast information scheduling and transmission (generated from the AMF or operating and maintenance (O&M)); measurement for mobility and scheduling and measurement report configuration; transport level packet marking in the uplink; session management; network slicing support; QoS flow management and mapping to a data radio bearer; supporting a UE in an inactive mode; NAS message distribution; NAS node selection; radio access network sharing; dual connectivity; and tight interworking between NR and E-UTRA.

The UE 101 may be referred to as user equipment. The user equipment may be referred to as a terminal, mobile equipment (ME), a mobile station (MS), or other terms. In addition, the user equipment may be a portable device such as a laptop, a cell phone, a personal digital assistant (PDA), a smartphone, or a multimedia device, or may be a device that cannot be carried, such as a personal computer (CP) or a vehicle-mounted device.

The NEF 111 may provide means for safely exposing, for example, 3^{rd} party, internal exposure/re-exposure application functions, and services and capabilities for edge computing, provided by 3GPP network functions. The NEF 111 may receive information (based on exposed capability(s) of other NF(s)) from other NF(s). The NEF 111 may store information received as data structured by using a standardized interface as a data storage network function. The stored information may be re-exposed to other NF(s) and AF(s) by the NEF 111, and may be used for other purposes such as analysis.

The NRF 115 may support a service discovery function. The NRF 115 may receive an NF discovery request from an NF instance, and may provide the NF instance with information of a discovered NF instance. In addition, the NRF 115 may maintain available NF instances and services supported thereby.

Meanwhile, although FIG. 1 illustrates a reference model in which the UE 101 accesses one DN 110 by using one PDU session for convenience of description, the disclosure is not limited thereto.

The UE 101 may simultaneously access two (that is, local and central) data networks by using multiple PDU sessions. Two SMFs may be selected for different PDU sessions. However, each SMF may be capable of controlling both the local UPF and central UPF in the PDU session.

In addition, the UE 101 may simultaneously access two (that is, local and central) data networks provided in a single PDU session.

The NSSF 114 may select a set of network slice instances that serve the UE 101. In addition, the NSSF 114 may determine allowed network slice selection assistance information (NSSAI) and, if necessary, may perform mapping regarding subscribed single-network slice selection assistance information (S-NSSAI). In addition, the NSSF 114 may determine configured NSSAI and, if necessary, may perform mapping regarding subscribed S-NSSAI. In addition, the NSSF 114 may determine an AMF set used to service the UE, or may query the NRF 115 according to configurations, thereby determining the list of candidate AMFs.

The NRF 115 may support a service discovery function. The NRF 115 may receive an NF discovery request from an NF instance, and may provide the NF instance with information of a discovered NF instance. In addition, the NRF 115 may maintain available NF instances and services supported thereby.

In 3GPP systems, conceptual links connecting NFs in the 5G system are defined as reference points. In the following, examples of reference points included in the 5G system architecture described in FIG. 1 are provided below.
N1: a reference point between a UE and an AMF
N2: a reference point between an (R)AN and an AMF
N3: a reference point between an (R)AN and a UPF
N4: a reference point between an SMF and a UPF
N5: a reference point between a PCF and an AF
N6: a reference point between a UPF and a data network
N7: a reference point between an SMF and a PCF
N8: a reference point between a UDM and an AMF
N9: a reference point between two core UPFs
N10: a reference point between a UDM and an SMF
N11: a reference point between an AMF and an SMF
N12: a reference point between an AMF and an AUSF
N13: a reference point between a UDM and an authentication server function (AUSF)
N14: a reference point between two AMFs
N15: a reference point between a PCF and an AMF for a non-roaming scenario, and a reference point between a PCF and an AMF in a visited network for a roaming scenario
N23: a reference point between a PCF and an NWDAF
N34: a reference point between an NSSF and an NWDAF

In the following descriptions, a UE may refer to the UE 101, and the terms UE and terminal may be used interchangeably. In this case, unless specifically defined additionally, a UE should be understood as the UE 101.

The network and core network included in the embodiments of the disclosure may be a concept including a network device. A mobility management device (or mobility management function), a location management device (or location management function), a gateway mobile location center, etc. may be configured as separate devices, respectively, and may be configured to be included in network devices.

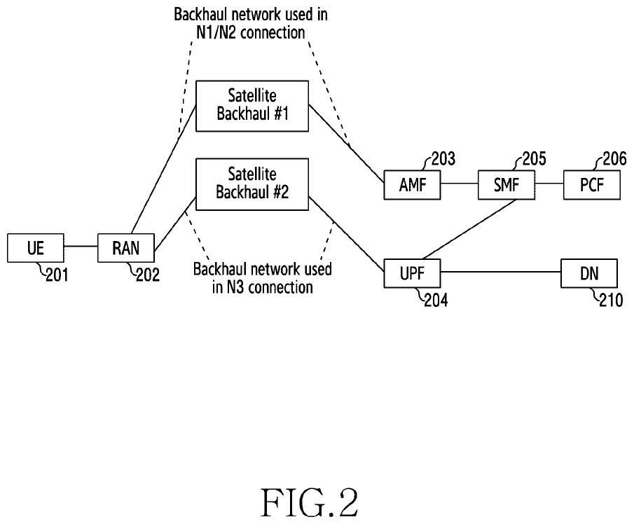

FIG. 2 illustrates a 5G system structure in case that one or more backhaul network connections are possible between one RAN and one 5G core network according to an embodiment of the disclosure.

Referring to FIG. 2, the UE 201 according to an embodiment may correspond to the UE 101 in FIG. 1, the RAN 202 may correspond to the RAN 102 in FIG. 1, and the AMF 230 may correspond to the AMF 103 in FIG. 1. The UPF 204 may correspond to the UPF 104 in FIG. 1, the SMF 205 may correspond to the SMF 105 in FIG. 1, and the PCF 206 may correspond to the PCF 106 in FIG. 1. The DN 210 may correspond to the DN 110 in FIG. 1.

According to an embodiment, at least one control plane backhaul network and/or at least one user plane backhaul network may be connected between one RAN 202 and one core network. The control plane backhaul network may connect between the RAN 202 and the AMF 203 and may use an N2 interface. The user plane backhaul network may connect between the RAN 202 and the UPF 204 and may use an N3 interface. The type of the backhaul network may include a terrestrial backhaul network and a non-terrestrial backhaul network (which uses satellites, drones, and the like). The satellite backhaul network may have one or more satellites connected thereto (e.g., low earth orbit (LEO), medium earth orbit (MEO), geo-stationary earth orbit (GEO)).

For example, as illustrated in FIG. 2, a first satellite backhaul network (satellite Backhaul #1) (for example, GEO) may be connected between the RAN 202 and the AMF 203 as a control plane backhaul network, and a second satellite backhaul network (satellite Backhaul #2) (for example, LEO) may be connected between the RAN 202 and the UPF 204 as a user plane backhaul network.

According to an embodiment, the type of the backhaul network, particularly the type of the satellite backhaul network may be considered when the PCF determines the SM policy. For example, the PCF may include a packet delay budget (PDB) value in connection with configuring a QoS parameter appropriate for the service provided to the UE 201. The PDB may correspond to the upper limit value of packet delay that may be allowed between the UE 210 and the N6 interface termination UPF 204. Therefore, in case that a satellite network is used in the section between the RAN 202 and the UPF, it may be necessary to determine an SM policy including a longer PDB value than when a terrestrial network is used.

According to an embodiment, the type of satellite backhaul networks connected to the control plane and/or user plane may be determined by the RAN 202, AMF 203, and/or SMF in the process of PDU session establishment for the UE 201 or a process of UE registration for PDU session establishment. For example, the AMF 203 may determine the type (for example, GEO) of a satellite backhaul network using N1 and N2 connections between the RAN 202 and the AMF 203, to which a UE registration request message and/or a PDU session establishment request message have been transmitted, in a UE registration process and/or PDU session establishment process.

According to an embodiment, the AMF 203 may be connected to one or more UPFs having a core network to which a RAN 202 to which a UE registration request message and/or a PDU session establishment request message have been transmitted belongs, by a satellite backhaul network using an N3 connection. The AMF 203 may determine that the same may be connected to a type of satellite backhaul network different from the satellite backhaul network used for connection to the AMF 203 (for example, a satellite type other than GEO). The AMF 203 may provide the SMF with an indicator to indicate that one or more satellite backhaul networks may be used.

According to an embodiment, the SMF may transfer or provide an indication to the PCF to indicate the type of a satellite backhaul network using N1 and N2 connections between the RAN 202 and AMF 203 (for example, the type of a satellite backhaul network used in the control plane), and/or that one or more satellite backhaul networks may be used (hereinafter, referred to as a multi-backhaul network support indication for convenience). The PCF may determine the SM policy, based on at least one of the type of a satellite backhaul network used in the control plane, or the multi-backhaul network support indication, and may provide the determined SM policy to the SMF. The SM policy may include policy and charging control (PCC) rules that follow the satellite type, respectively.

According to an embodiment, the SMF may select a UPF, based on the SM policy, and may transfer PCC rules that follow the satellite type to the RAN 202. The RAN 202 may determine the type of a satellite backhaul network that may be used between the UPF and the RAN 202, and may determine an acceptable QoS parameter, based on network delay that occurs in the determined satellite backhaul network. The RAN 202 may distinguish acceptable ones and rejected ones in the list of QoS parameters provided by the SMF, and may notify the SMF thereof. additionally, the RAN 202 may also provide the SMF with information on the type of a satellite backhaul (e.g., a satellite backhaul network used in the user plane) network using an N3 connection between the RAN 202 and the UPF.

According to an embodiment, the SMF may determine the type of a satellite backhaul network used in the user plane, based on information received from the RAN 202. The SMF may provide the AMF 203 with the determined type of backhaul network. The AMF 203 may distinguish and store the type of a satellite backhaul network used in the control plane and the type of a satellite backhaul network used in the user plane.

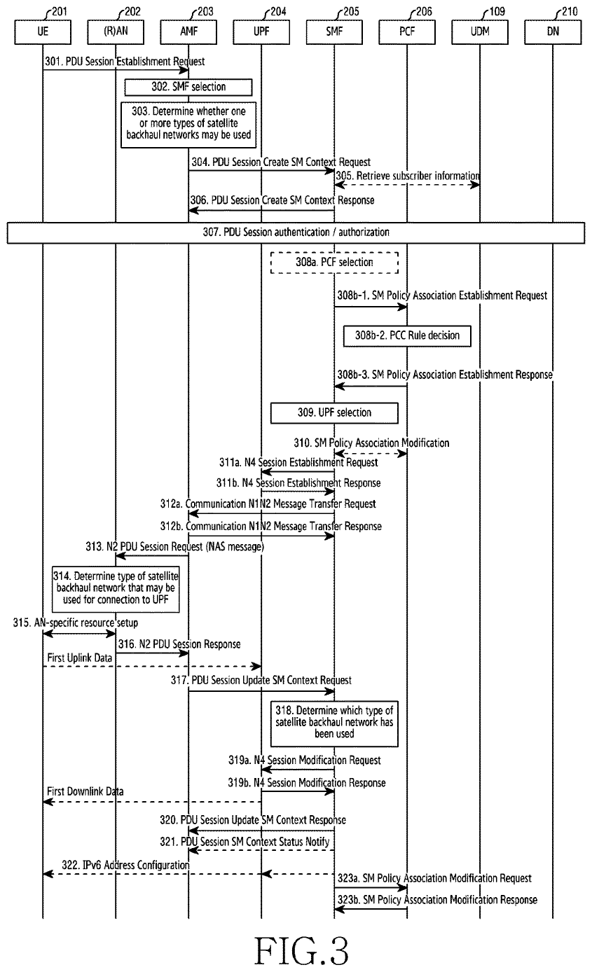

FIG. 3 illustrates a procedure of establishing a PDU session in a 5G system in case that one or more backhaul network connections are possible between one RAN 202 and one 5G core network according to an embodiment of the disclosure.

According to an embodiment of the disclosure, the UE 201 may send a PDU session establishment request to the AMF 203 in step 301.

According to an embodiment, the AMF 203 may select the SMF 205 in step 302.

According to an embodiment, the AMF 203 may determine, check or identify whether more than one types of backhaul network may be used by the RAN 202 to which a PDU session establishment request message has been transmitted, in connection with the connection to the core network, in step 303. For example, in case that the backhaul network used for the N1 and/or N2 connection between the RAN 202 and the AMF 203 and the backhaul network used for the N3 connection between the RAN 202 and the UPF 204 have or may have different satellite types, the AMF 203 may determine that one or more types of satellite backhaul networks may be used to connect the RAN 202 and the core network.

According to an embodiment, the AMF 203 may request the SMF 205 to establish a PDU session (PDU session create SM context request) in step 304. For example, the PDU session establishment request may include a satellite backhaul category (e.g., UNKNOWN) and a multi-backhaul network support indication. In case of determining that one or more types of satellite backhaul networks may be used to connect the RAN 202 and the core network in step 303, the AMF 203 may provide the SMF with at least one of the satellite backhaul category or the multi-backhaul network support indication. The satellite backhaul category may be a value (for example, GEO) indicating the type of a satellite backhaul network used in the control plane. Alternatively, the satellite backhaul category indicate the type of a satellite backhaul network used in the user plane, and may be a value (for example, UNKNOWN) indicating that the type cannot be determined. The multi-backhaul network support indication may be an indicator indicating that one or more types of satellite backhaul networks may be used to connect the RAN 202 and the core network.

According to an embodiment, the SMF may retrieve subscriber information from the UDM 109 in step 305. For example, the SMF may request and retrieve session management subscription data from the UDM (subscription retrieval). The UDM may request and receive session management subscription data from the DUR and may then provide the same to the SMF. For example, the SMF may request the UDM to notify the SMF of the occurrence of a change in the session management subscription data in case that such a change in the subscription data occurs (subscribes to be notified when this subscription data is notified). The UDM may request the UDR to notify the UDM of the occurrence of a change in the session management subscription data in case that such a change in the subscription data occurs, in the same manner as the SMF has requested a notification.

According to an embodiment, the SMF may send a response to the PDU session establishment request to the AMF 203 (PDU session create SM context response) in step 306.

According to an embodiment, a PDU session authentication and/or authorization procedure may be performed (PDU session authentication/authorization) in step 307.

According to an embodiment, the SMF may select the PCF 206 (PCF selection) in step 308a.

According to an embodiment, the SMF may send an SM policy association establishment request to the PCF in step 308b-1. The SM policy association establishment request may include at least one of the satellite backhaul category (e.g., UNKNOWN) or the multi-backhaul network support indication provided from the AMF 203 to the SMF in step 304.

According to an embodiment, the PCF may determine policy and charging control (PCC) rules, based on information received from the SMF (PCC rule decision) in step 308b-2.

According to an embodiment, the PCF may provide the SMF with the determined PCC rules (SM policy association establishment response) in step 308b-3. The determined PCC rules may include PCC rules that follow the satellite type. For example, in case of receiving the multi-backhaul network support indication from the SMF, the PCF may together provide PCC rules for a different type of satellite from the type of satellite indicated by the satellite backhaul category. In case that the satellite backhaul category is configured to be “UNKNOWN,” or in case that the satellite backhaul category is not provided, the PCF may together provide PCC rules for all types of satellites, respectively. For example, PCC rules transferred or transmitted from the PCF to the SMF may include PCC rules of each type of backhaul network. For example, the PCC rules of each type of backhaul network may include at least one of PCC rules for low earth orbit (LEO), PCC rules for medium earth orbit (MEO), PCC rules for geo-stationary earth (GEO), PCC rules for other satellite types (OTHERSAT), or PCC rules for terrestrial network.

According to an embodiment, the SMF may select the UPF 204 (UPF selection) in step 309. The SMF may refer to information received from the AMF 203 in step 304, and the information received from the AMF 203 may include a satellite backhaul category and/or a multi-backhaul network support indication.

According to an embodiment, the SMF may perform a session management (SM) policy modification procedure with the PCF (SM policy association modification) in step 310.

According to an embodiment, the SMF may perform an N4 session establishment procedure with the UPF. The SMF may provide the UPF with at least one of information related to the satellite backhaul network used in the control plane, or information indicating that one or more types of satellite backhaul networks may be used in the control plane and the user plane. For example, the SMF may transmit or send a session connection request (for example, N4 session establishment request) to the UPF in step 311a. The UPF may transmit or send a response (for example, N4 session establishment response) to the session connection request to the SMF in step 311b.

According to an embodiment, the SMF may provide the AMF 203 with session-related information. The session-related information may include PCC rules for each satellite backhaul network type received from the PCF in step 308b-3. For example, the SMF may transmit a communication message transmission request (for example, communication N1N2 message transfer request) to the AMF 203 in step 312a. For example, the AMF 203 may transmit a response (for example, communication N1N2 message transfer response) to the communication message transmission request to the SMF in step 312b.

According to an embodiment, the AMF 203 may provide or transmit session-related information to the RAN 202 (N2 PDU session request (NAS message)) in step 313. The session-related information may include PCC rules for each satellite backhaul network type received from the SMF in step 312a and/or step 312b.

According to an embodiment, the RAN 202 may determine the type of satellite backhaul network that may be used for the connection to the UPF using N3 in step 314. In addition, the RAN 202 may determine acceptable QoS parameters, based on the network delay occurring in the satellite backhaul network that may be used for the connection to the UPF using N3. The RAN 202 may distinguish QoS flow identifiers (QFIs) having acceptable QoS parameters (hereinafter, referred to as accepted QFI(s)) and QFIs having unacceptable QoS parameters (hereinafter, referred to as rejected QFI(s)). (RAN may determine which type of backhaul network is used over N3, and accept only the QFI(s) for that type of backhaul network)

According to an embodiment, the RAN 202 may perform an AN resource setup with the UE 201 in step 315. The RAN 202 may provide or transmit the NAS message received through steps 311a, 312a, and 313 to the UE 201. The received NAS message may include a PDU session establishment accept. (AN-specific resource setup (PDU session establishment accept)

According to an embodiment, the RAN 202 may provide AN tunnel information to the AMF 203 in step 316. For example, RAN 202 may transmit an N2 PDU session response to the AMF 203, and the N2 PDU session response may include AN tunnel information, accepted QFI(s), and/or rejected QFI(s). The accepted QFI(s) and/or rejected QFI(s) may be included in N2 sm information. In addition, according to the determination in step 314, the RAN 202 may provide or transmit accepted QFI(s) and/or rejected QFI(s) determined based on the network delay occurring in the satellite backhaul network that may be used for the connection to the UPF using N3, to the AMF 203. After step 316, uplink data received from the UE 201 may be transferred to the core network.

According to an embodiment, the AMF 203 may provide information received in step 316 to the SMF in step 317. For example, the AMF 203 may provide or transmit a PDU session update SM context request including P2 SM information to the SMF.

According to an embodiment, the SMF may determine which type of satellite backhaul network has been used for the N3 connection, based on the accepted QFI(s) and/or rejected QFI(s) received through step 316 and/or step 317, in step 318. For example, in case that the accepted QFI includes a PDB parameter having a value that may be guaranteed in the LEO satellite, and the rejected QFI includes a PDB parameter having a value that may be guaranteed in the MEO and GEO satellites, the SMF may determine that the LEO satellite backhaul network has been used for the N3 connection. (SMF may determine which type of backhaul network is used over N3 based on the received accepted QFI(s) and/or rejected QFI(s) from (R)AN).

According to an embodiment, the SMF may perform an N4 session modification procedure with the UPF. For example, the SMF may transmit an N4 session modification request to the UPF in step 319a. For example, the UPF may transmit an N4 session modification response to the SMF in step 319b. The SMF may provide the UPF with information (for example, LEO) regarding the type of satellite backhaul network used for the N3 connection, determined in step 318. After step 319, downlink data received from the DN 210 may be transferred to the UE 201.

According to an embodiment, the SMF may update information on the PDU session for the AMF 203 in step 320. For example, the SMF may provide or transmit a PDU session update SM context response including information on the satellite backhaul category to the AMF 203. In an embodiment, the satellite backhaul category may be determined in step 318, and may include LEO, MEO, GEO, OTHERSAT, and/or DYNAMIC. The SMF may provide the AMF 203 with information (for example, LEO) regarding the type of satellite backhaul network used for the N3 connection, specified in step 318. For example, the SMF may provide the AMF with a satellite backhaul category having the value of “LEO.” In case that the satellite backhaul category value has been configured to be “UNKNOWN” in step 314, the AMF 203 may change the value to “LEO.” Alternatively, the AMF may distinguish and store the type of satellite backhaul network used in the control plane and the type of satellite backhaul network used in the user plane, and may store “LEO” as the type of satellite backhaul network used in the user plane.

According to an embodiment, the SMF may notify the AMF of the SM context status (PDU session SM context status notify) in step 321.

According to an embodiment, the SMF may request the UPF and/or the UE 201 to provide an IPV6 address configuration in step 322.

According to an embodiment, the SMF may request the PCF to update the SM policy. For example, the SMF may provide or transmit an SM policy association modification request to the PCF in step 323a. For example, the SM policy association modification request may include information on the satellite backhaul category determined in step 318 (for example, LEO, MEO, GEO, OTHERSAT, or DYNAMIC). In embodiment, the PCF may provide or transmit an SM policy association modification response to the SMF in step 323b.

The SM policy update request may include information (for example, LEO) regarding the type of satellite backhaul network used for the N3 connection, specified in step 318. For example, the SMF may provide the PCF with a satellite backhaul category having the value of “LEO.”

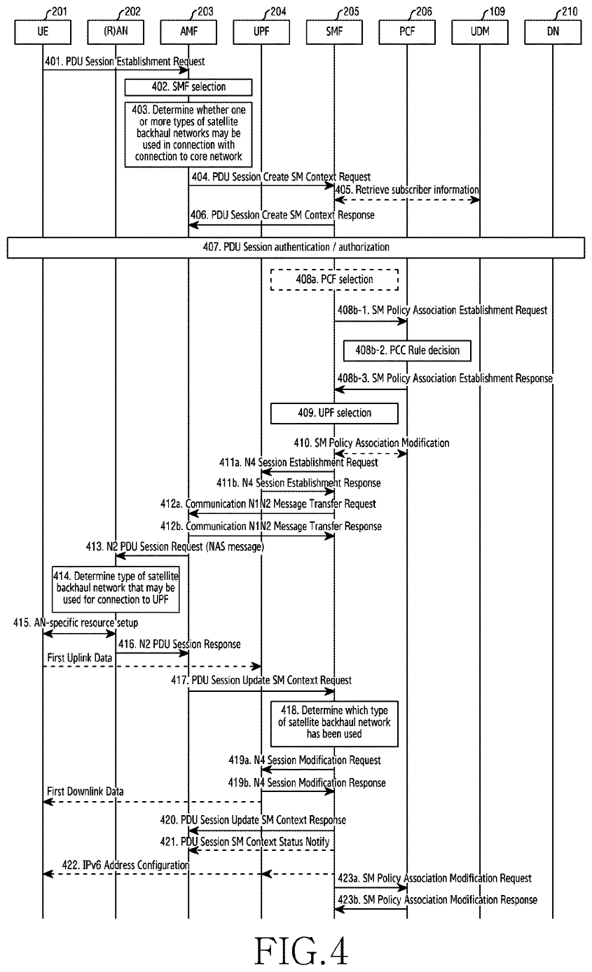

FIG. 4 illustrates a procedure of establishing a PDU session in a 5G system in case that one or more backhaul network connections are possible between one RAN and one 5G core network according to an embodiment of the disclosure.

Referring to FIG. 4, the UE according to an embodiment may request the AMF 203 to establish a PDU session in step 401. For example, the UE 201 may transmit a PDU session establishment request to the AMF 203.

According to an embodiment, the AMF 203 may select the SMF 205 in step 402.

According to an embodiment, the AMF 203 may determine whether one or more types of satellite backhaul network may be used by the RAN 202 to which a PDU session establishment request message has been transmitted, in connection with the connection to the core network, in step 403. For example, in case that the backhaul network used for the N1 and/or N2 connection between the RAN 202 and the AMF 203 and the backhaul network used for the N3 connection between the RAN 202 and the UPF have or may have different satellite types, the AMF 203 may determine that one or more types of satellite backhaul networks may be used to connect the RAN 202 and the core network. (AFM may determine whether more than one types of backhaul network may be used).

According to an embodiment, the AMF 203 may request the SMF to establish a PDU session in step 404. In case of determining that one or more types of satellite backhaul networks may be used to connect the RAN 202 and the core network in step 403, the AMF 203 may provide the SMF with at least one of the satellite backhaul category used in control plane, or the multi-backhaul network support indication. For example, the AMF 203 may transmit a PDU session create SM context request to the SMF. In an embodiment, the PDU session create SM context request may include a satellite backhaul category (for example, GEO) and/or a multi-backhaul network support indication. In an embodiment, the satellite backhaul category may be used in the control plane.

The satellite backhaul category used in control plane may be a value (for example, GEO) indicating the type of a satellite backhaul network used in the control plane. The multi-backhaul network support indication may be an indicator indicating that one or more types of satellite backhaul networks may be used to connect the RAN 202 and the core network.

According to an embodiment, the SMF may retrieve subscriber information from the UDM 109 in step 405. For example, the SMF may request and retrieve session management subscription data from the UDM (subscription retrieval). The UDM may request and receive session management subscription data from the DUR and may then provide the same to the SMF. For example, the SMF may request the UDM to notify the SMF of the occurrence of a change in the session management subscription data in case that such a change in the subscription data occurs (subscribes to be notified when this subscription data is notified). The UDM may request the UDR to notify the UDM of the occurrence of a change in the session management subscription data in case that such a change in the subscription data occurs, in the same manner as the SMF has requested a notification.

According to an embodiment, the SMF may respond to the PDU session establishment request of the AMF 203 in step 406. For example, the SMF may transmit a response to the PDU session establishment request to the AMF 203. (PDU session create SM context response).

According to an embodiment, a PDU session authentication and/or authorization procedure may be performed (PDU session authentication/authorization) in step 407.

According to an embodiment, the SMF may select the PCF 206 (PCF selection) in step 408a.

According to an embodiment, the SMF may request the PCF to provide an SM policy in step 408b-1. For example, the SMF may transmit an SM policy association establishment request to the PCF. The SM policy request may include at least one of the satellite backhaul category used in control plane (for example, GEO), or the multi-backhaul network support indication provided from the AMF 203 to the SMF in step 404.

According to an embodiment, the PCF may determine PCC rules, based on information received from the SMF (PCC rule decision) in step 408b-2.

According to an embodiment, the PCF may provide the SMF with the determined PCC rules in step 408b-3. The PCC rules may include PCC rules that follow the satellite type. For example, in case of receiving the multi-backhaul network support indication from the SMF, the PCF may together provide the SMF with PCC rules for a different type of satellite from the type of satellite indicated by the satellite backhaul category used in control plane. In case that the satellite backhaul category used in control plane is configured to be “GEO,” PCC rules for different types of satellites other than GEO may be provided, respectively. For example, at least one of PCC rules for LEO, PCC rules for MEO, or PCC rules for terrestrial network may be provided to the SMF. As another example, in case that the satellite backhaul category used in control plane is not provided, the PCF may together provide PCC rules for all types of satellites, respectively, to the SMF. For example, at least one of PCC rules for LEO, PCC rules for MEO, PCC rules for GEO, or PCC rules for terrestrial network may be provided to the SMF. According to an embodiment, the PCF may provide or transmit an SM policy association establishment response to the SMF in step 408b-3. For example, the SM policy association establishment response may include PCC rules of each type of backhaul network. For example, the PCC rules of each type of backhaul network may include PCC rules for LEO, PCC rules for MEO, PCC rules GEO, PCC rules for OTHERSAT, and/or PCC rules for terrestrial. In an example, the OTHERSAT may be referred to a classification or type of satellites other than a predefined satellite type. Alternatively, the OTHERSAT may be referred to as a classification or type of satellites other than LEO, MEO, and GEO.

According to an embodiment, the SMF may select the UPF (UPF selection) in step 409. The SMF may refer to information received from the AMF 203 in step 404, and the received information may include a satellite backhaul category used in control plane, a multi-backhaul network support indication.

According to an embodiment, the SMF may perform an SM policy modification procedure with the PCF in step 410.

According to an embodiment, the SMF may perform an N4 session establishment procedure with the UPF. For example, the SMF may provide or transmit a session establishment request (for example, N4 session establishment request) to the UPF in step 411a. For example, the UPF may provide or transmit a session establishment response (for example, N4 session establishment response) to the SMF in step 411b. The SMF may transmit at least one of information related to the satellite backhaul network used in the control plane, or information indicating that one or more types of satellite backhaul networks may be used in the control plane and the user plane, to the UPF.

According to an embodiment, the SMF may provide the AMF 203 with session-related information. The session-related information may include PCC rules for each satellite backhaul network type received from the PCF in step 408b-3. For example, the SMF may provide or transmit a communication message transmission request (for example, communication N1N2 message transfer request) to the AMF 203 in step 412a. For example, the AMF 203 may provide or transmit a response (for example, communication N1N2 message transfer response) to the communication message transmission request to the SMF in step 412b.

According to an embodiment, the AMF 203 may provide session-related information to the RAN 202 in step 413. The session-related information may include PCC rules for each satellite backhaul network type received from the SMF in step 412. According to an embodiment, the AMF 203 may transmit or provide an N2 PDU session request to the RAN 202 in step 413. In an embodiment, the N2 PDU session request may be a NAS message.

According to an embodiment, the RAN 202 may determine the type of satellite backhaul network that may be used for the connection to the UPF using N3 in step 414. In addition, the RAN 202 may determine acceptable QoS parameters, based on the network delay occurring in the satellite backhaul network that may be used for the connection to the UPF using N3. The RAN 202 may distinguish QFIs having acceptable QoS parameters (hereinafter, referred to as accepted QFI(s)) and QFIs having unacceptable QoS parameters (hereinafter, referred to as rejected QFI(s)). (RAN may determine which type of backhaul network is used over N3 and accept only the QFI(s) for that type of backhaul network).

According to an embodiment, the RAN 202 may perform an AN-specific resource setup with the UE 201 in step 415. The RAN 202 may provide the NAS message received through steps 411a, 412a, and/or 413 to the UE 201. The received NAS message may include a PDU session establishment accept.

According to an embodiment, the RAN 202 may provide AN tunnel information to the AMF 203 in step 416. In addition, according to the determination in step 414, the RAN 202 may provide accepted QFI(s) and/or rejected QFI(s) determined based on the network delay occurring in the satellite backhaul network that may be used for the connection to the UPF using N3, to the AMF 203. In addition, according to the determination in step 414, the RAN 202 may provide the type of satellite backhaul network that may be used for the connection to the UPF using N3. For example, the RAN 202 may provide the AMF 203 with a satellite backhaul category used in user plane, and the value thereof may be configured to be LEO. After step 414, uplink data received from the UE 201 may be transferred to the core network. According to an embodiment, the RAN 202 may transmit or provide an N2 PDU session response to the AMF 203 in step 416. For example, the N2 PDU session response may include AN tunnel information, accepted QFI(s), rejected QFI(s), and/or a satellite backhaul category used in user plane.

According to an embodiment, the AMF 203 may provide information received in step 416 to the SMF in step 417. For example, the AMF 203 may transmit a PDU session update SM context request to the SMF. The PDU session update SM context request may include N2 SM information.

According to an embodiment, the SMF may determine which type of satellite backhaul network has been used for the N3 connection, based on the accepted QFI(s), rejected QFI(s), and/or satellite backhaul category used in user plane, received through step 416 and/or step 417, in step 418. For example, in case that the accepted QFI includes a PDB parameter having a value that may be guaranteed in the LEO satellite, and the rejected QFI includes a PDB parameter having a value that may be guaranteed in the MEO and GEO satellites, the SMF may determine that the LEO satellite backhaul network has been used for the N3 connection. As another example, in case that the satellite backhaul category used in user plane is configured to be LEO, the SMF may determine that the LEO satellite backhaul network has been used for the N3 connection. (SMF may determine which type of backhaul network is used over N3 based on the received accepted/rejected QFI(s) and Satellite Backhaul category used in user plane form (R)AN.)

The SMF may perform an N4 session modification procedure with the UPF. For example, the SMF may provide or transmit a session modification request (for example, N4 session modification request) to the UPF in step 419a. The UPF may provide or transmit a response (for example, N4 session modification response) to the session modification request to the SMF in step 419b. The SMF may provide the UPF with information (for example, LEO) regarding the type of satellite backhaul network used for the N3 connection, determined in step 418. After step 419b, downlink data received from the DN may be transferred to the UE 201.

According to an embodiment, the SMF may update information on the PDU session for the AMF 203 in step 420. The SMF may provide the AMF 203 with information (for example, LEO) regarding the type of satellite backhaul network used for the N3 connection, specified in step 418. For example, the SMF may provide the AMF 203 with a satellite backhaul category used in user plane, having the value of “LEO.” The AMF 203 may distinguish and store the type of satellite backhaul network used in the control plane and the type of satellite backhaul network used in the user plane, and may store “LEO” as the type of satellite backhaul network used in the user plane. For example, the AMF 203 may store a satellite backhaul category used in user plane having the value of “LEO” separately from the satellite backhaul category used in user plane stored in step 404. According to an embodiment, the SMF may provide or transmit a PDU session update SM context response to the AMF 203 in step 420. In an embodiment, the PDU session update SM context response may be determined in step 418 and may include a satellite backhaul category used in user plane. For example, the satellite backhaul category may include LEO, MEO, GEO, OTHERSAT, and/or DYNAMIC.

According to an embodiment, the SMF may notify the AMF 203 of the SM context status (PDU session SM context status notify) in step 421.

According to an embodiment, the SMF may request the UPF and/or the UE 201 to provide an IPv6 address configuration in step 422.

According to an embodiment, the SMF may request the PCF to update the SM policy. For example, the SMF may transmit an SM policy association modification request to the PCF in step 423a. In an example, the SM policy association modification request may include a satellite backhaul category used in user plane. For example, the satellite backhaul category may include LEO, MEO, GEO, OTHERSAT, and/or DYNAMIC. For example, the PCF may provide or transmit an SM policy association modification response to the SMF in step 423b.

The SM policy update request may include information (for example, LEO) regarding the type of satellite backhaul network used for the N3 connection, specified in step 418. For example, the SMF may provide the PCF with a satellite backhaul category used in user plane, having the value of “LEO.”

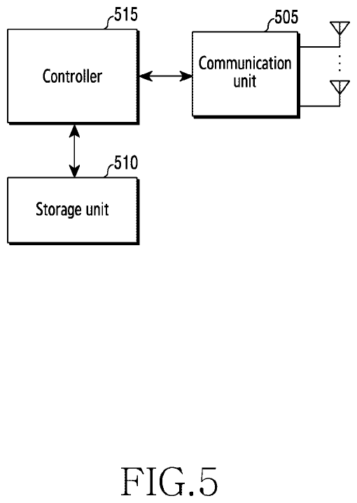

FIG. 5 illustrates an example of a functional structure of a UE according to an embodiment of the disclosure: and The structure illustrate din FIG. 5 may be understood as a structure of the UE 201 in FIG. 2 or the UE 101 in FIG. 1. The terms “ . . . unit”, “ . . . device”, etc. used hereinafter may refer to a unit configured to process at least one function or operation, and may be implemented as hardware, software, or a combination of hardware and software.

Referring to FIG. 5, the UE includes a communication unit 505, a storage unit 510, and a controller 515.

The communication unit 505 performs functions for transmitting/receiving signals through a radio channel. For example, the communication unit 505 performs functions of conversion between baseband signals and bitstrings according to the physical layer specifications of the system. For example, in case of data transmission, the communication unit 505 generates complex symbols by encoding and modulating a transmission bitstring. In addition, in case of data reception, the communication unit 505 demodulates and decodes a baseband signal to restore a received bitstring. In addition, the communication unit 505 up-converts a baseband signal to an RF band signal, transmits the same through an antenna, and down-converts an RF band signal received through the antenna to a baseband signal. For example, the communication unit 505 may include a transmission filter, a reception filter, an amplifier, a mixer, an oscillator, a DAC, and an ADC.

In addition, the communication unit 505 may include multiple transmission/reception paths. Moreover, the communication unit 505 may include at least one antenna array including multiple antenna elements. In terms of hardware, the communication unit 505 may include a digital circuit and an analog circuit (e.g., a radio frequency integrated circuit (RFIC)). The digital circuit and the analog circuit may be implemented as a single package. In addition, the communication unit 505 may include multiple RF chains. Furthermore, the communication unit 505 may perform beamforming.

The communication unit 505 transmits and receives signals as described above. Accordingly, all or part of the communication unit 505 may be referred to as a “transmitter”, a “receiver”, or a “transceiver”. In addition, as used in the following description, the meaning of “transmission and reception performed through a radio channel” includes the meaning that the above-described processing is performed by the communication unit 505.

The storage unit 510 stores data such as basic programs, application programs, and configuration information for operations of the UE. The storage unit 510 may include a volatile memory, a nonvolatile memory, or a combination of a volatile memory and a nonvolatile memory. In addition, the storage unit 510 provides the stored data at the request of the controller 515.

The controller 515 controls the overall operation of the UE. For example, the controller 515 transmits/receives signals through the communication unit 505. In addition, the controller 515 records data in the storage unit 510 and reads the data from the storage unit 510. In addition, the controller 515 may perform functions of protocol stacks required by communication specifications. To this end, the controller 510 may include at least one processor or microprocessor, or may be a part of a processor. In addition, a part of the communication unit 505 and the controller 515 may be referred to as a communication processor (CP). According to various embodiments, the controller 515 may control to perform synchronization by using a wireless communication network. For example, the controller 515 may control the UE to perform operations according to various embodiments described below.

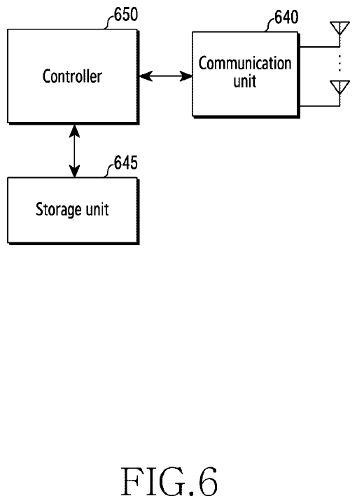

FIG. 6 illustrates an example of a functional structure of a core network entity according to an embodiment of the disclosure. A structure of a core network entity in a wireless communication system according to various embodiments of the disclosure is illustrated. The structure illustrated in FIG. 6 may be understood as a structure of a device having at least one function among network entities including the UPF 104 in FIG. 1. The terms “ . . . unit”, “ . . . device”, etc. used hereinafter may refer to a unit configured to process at least one function or operation, and may be implemented as hardware, software, or a combination of hardware and software.

Referring to FIG. 6, the core network entity may include a communication unit 640, a storage unit 645, and a controller 650.

The communication unit 640 provides an interface for communicating with other devices in the network. That is, the communication unit 640 converts a bitstring, transmitted from the core network entity to any other device, into a physical signal, and converts a physical signal, received from any other device, into a bitstring. The communication unit 640 may transmit/receive signals. Accordingly, the communication unit 640 may be referred to as a modem, a transmitter, a receiver, or a transceiver. The communication unit 640 enables the core network entity to communicate with other devices or the system via a backhaul connection (e.g., wired backhaul or wireless backhaul) or via a network.

The storage unit 645 stores data such as basic programs, application programs, and configuration information for operations of the core network entity. The storage 645 may include a volatile memory, a nonvolatile memory, or a combination of a volatile memory and a nonvolatile memory. In addition, the storage unit 645 provides the stored data at the request of the controller 650.

The controller 650 controls the overall operation of the core network entity. For example, the controller 650 transmits/receives signals through the communication unit 640. In addition, the controller 650 records data in the storage unit 645 and reads the data from the storage unit 645. To this end, the controller 650 may include at least one processor. According to various embodiments, the controller 650 may control to perform synchronization by using a wireless communication network. For example, the controller 650 may control the core network entity to perform operations according to various embodiments described below.

Advantageous effects obtainable from the disclosure may not be limited to the above-mentioned effects, and other effects which are not mentioned may be clearly understood from the following descriptions by those skilled in the art to which the disclosure pertains.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. Moreover, other variants based on the technical idea of the embodiments may also be implemented in various systems such as FDD LTE, TDD LTE, and 5G or NR systems.

According to an embodiment, a method performed by an access and mobility management function (AMF) entity in a wireless communication system may include: receiving a request regarding establishment of a protocol data unit (PDU) session from a base station; in case that two or more backhaul networks are used for the PDU session, transmitting a PDU session establishment request including first information on a satellite backhaul category and second information indicating that the two or more backhaul networks are used, to a session management function (SMF) entity; receiving quality of service (QoS) information of a plurality of backhaul networks for determining a first backhaul network to be used in a user plane, among the two or more backhaul networks, based on the first information and the second information, from the SMF entity; transmitting the QoS information to the base station; receiving information indicating a first category of the first backhaul network, among the plurality of backhaul networks, based on the QoS information, from the base station; and transmitting information indicating the first category to the SMF entity.

According to an embodiment, the PDU session establishment request may include information indicating that the first category of the first backhaul network used in the user plane is unknowable, or information indicating a second category of a second backhaul network used in a control plane.

According to an embodiment, in case that the PDU session establishment request may include information indicating that the first category of the first backhaul network is unknowable, the QoS information may include QoS information of all of the plurality of backhaul networks, and in case that the PDU session establishment request may include information indicating the second category of the second backhaul network used in the control plane, the QoS information may include QoS information of backhaul networks other than the second backhaul network, among the plurality of backhaul networks.

According to an embodiment, the information indicating the first category may include information on an accepted QoS flow identifier (QFI) and a rejected QFI, or an indicator for the first backhaul network.

According to an embodiment, an access and mobility management function (AMF) entity in a wireless communication system may include a transceiver and a controller coupled to the transceiver. The controller may be configured to: receive a request regarding establishment of a protocol data unit (PDU) session from a base station; in case that two or more backhaul networks are used for the PDU session, transmit a PDU session establishment request including first information on a satellite backhaul category and second information indicating that the two or more backhaul networks are used, to a session management function (SMF) entity; receive quality of service (QoS) information of a plurality of backhaul networks for determining a first backhaul network to be used in a user plane, among the two or more backhaul networks, based on the first information and the second information, from the SMF entity: transmit the QoS information to the base station; receive information indicating a first category of the first backhaul network, among the plurality of backhaul networks, based on the QoS information, from the base station; and transmit information indicating the first category to the SMF entity.

According to an embodiment, the PDU session establishment request may include information indicating that the first category of the first backhaul network used in the user plane is unknowable, or information indicating a second category of a second backhaul network used in a control plane.

According to an embodiment, in case that the PDU session establishment request may include information indicating that the first category of the first backhaul network is unknowable, the QoS information may include QoS information of all of the plurality of backhaul networks, and in case that the PDU session establishment request may include information indicating the second category of the second backhaul network used in the control plane, the QoS information may include QoS information of backhaul networks other than the second backhaul network, among the plurality of backhaul networks.

According to an embodiment, the information indicating the first category may include information on an accepted QoS flow identifier (QFI) and a rejected QFI, or an indicator for the first backhaul network.

According to an embodiment, a method performed by a session management function (SMF) entity in a wireless communication system may include: in case that two or more backhaul networks are used for a protocol data unit (PDU) session, receiving a PDU session establishment request including first information on a satellite backhaul category and second information indicating that the two or more backhaul networks are used, from an access and mobility management function (AMF) entity; transmitting a session management (SM) policy request including the first information and the second information to a policy control function (PCF) entity; receiving quality of service (QoS) information of a plurality of backhaul networks for determining a first backhaul network to be used in a user plane, among the two or more backhaul networks, based on the first information and the second information, from the PCF entity; transmitting the QoS information of the plurality of backhaul networks to the AMF entity; and receiving information indicating a first category of the first backhaul network, among the plurality of backhaul networks, based on the QoS information, from the AMF entity.

According to an embodiment, the PDU session establishment request may include information indicating that the first category of the first backhaul network used in the user plane is unknowable, or information indicating a second category of a second backhaul network used in a control plane.

According to an embodiment, in case that the PDU session establishment request may include information indicating that the first category of the first backhaul network is unknowable, the QoS information may include QoS information of all of the plurality of backhaul networks, and in case that the PDU session establishment request may include information indicating the second category of the second backhaul network used in the control plane, the QoS information may include QoS information of backhaul networks other than the second backhaul network, among the plurality of backhaul networks.

According to an embodiment, the information indicating the first category may include information on an accepted QoS flow identifier (QFI) and a rejected QFI, or an indicator for the first backhaul network.

According to an embodiment, a session management function (SMF) entity in a wireless communication system may include a transceiver and a controller coupled to the transceiver. The controller may be configured to: in case that two or more backhaul networks are used for a protocol data unit (PDU) session, receive a PDU session establishment request including first information on a satellite backhaul category and second information indicating that the two or more backhaul networks are used, from an access and mobility management function (AMF) entity; transmit a session management (SM) policy request including the first information and the second information to a policy control function (PCF) entity; receive quality of service (QoS) information of a plurality of backhaul networks for determining a first backhaul network to be used in a user plane, among the two or more backhaul networks, based on the first information and the second information, from the PCF entity; transmit the QoS information of the plurality of backhaul networks to the AMF entity; and receive information indicating a first category of the first backhaul network, among the plurality of backhaul networks, based on the QoS information, from the AMF entity.

According to an embodiment, in connection with the SMF entity, the PDU session establishment request may include information indicating that the first category of the first backhaul network used in the user plane is unknowable, or information indicating a second category of a second backhaul network used in a control plane.

According to an embodiment, in case that the PDU session establishment request may include information indicating that the first category of the first backhaul network is unknowable, the QoS information may include QoS information of all of the plurality of backhaul networks, and in case that the PDU session establishment request may include information indicating the second category of the second backhaul network used in the control plane, the QoS information may include QoS information of backhaul networks other than the second backhaul network, among the plurality of backhaul networks.

1. A method performed by an access and mobility management function (AMF) entity in a wireless communication system, the method comprising:
receiving, from a base station, a request regarding establishment of a protocol data unit (PDU) session;
in case that two or more backhaul networks are used for the PDU session, transmitting, to a session management function (SMF) entity, a PDU session establishment request comprising first information on a satellite backhaul category and second information indicating that the two or more backhaul networks are used;
receiving, from the SMF entity, quality of service (QoS) information of a plurality of backhaul networks for determining a first backhaul network to be used in a user plane, among the two or more backhaul networks, based on the first information and the second information;
transmitting, to the base station, the QoS information;
receiving, from the base station, information indicating a first category of the first backhaul network among the plurality of backhaul networks, based on the QoS information; and
transmitting, to the SMF entity, information indicating the first category.

2. The method of claim 1, wherein the PDU session establishment request comprises information indicating that the first category of the first backhaul network used in the user plane is unknowable, or information indicating a second category of a second backhaul network used in a control plane.

3. The method of claim 2, wherein, in case that the PDU session establishment request comprises information indicating that the first category of the first backhaul network is unknowable, the QoS information comprises QoS information of all of the plurality of backhaul networks, and
wherein, in case that the PDU session establishment request comprises information indicating the second category of the second backhaul network used in the control plane, the QoS information comprises QoS information of backhaul networks other than the second backhaul network, among the plurality of backhaul networks.

4. The method of claim 1, wherein the information indicating the first category comprises information on an accepted QoS flow identifier (QFI) and a rejected QFI, or an indicator for the first backhaul network.

5. An access and mobility management function (AMF) entity in a wireless communication system, the AMF entity comprising:
a transceiver; and
a controller coupled to the transceiver,
wherein the controller is configured to:
receive, from a base station, a request regarding establishment of a protocol data unit (PDU) session;
in case that two or more backhaul networks are used for the PDU session, transmit, to a session management function (SMF) entity, a PDU session establishment request comprising first information on a satellite backhaul category and second information indicating that the two or more backhaul networks are used;
receive, from the SMF entity, quality of service (QoS) information of a plurality of backhaul networks for determining a first backhaul network to be used in a user plane, among the two or more backhaul networks, based on the first information and the second information;
transmit, to the base station, the QoS information;
receive, from the base station, information indicating a first category of the first backhaul network, among the plurality of backhaul networks, based on the QoS information; and
transmit, to the SMF entity, information indicating the first category.

6. The AMF entity of claim 5, wherein the PDU session establishment request comprises information indicating that the first category of the first backhaul network used in the user plane is unknowable, or information indicating a second category of a second backhaul network used in a control plane.

7. The AMF entity of claim 6, wherein, in case that the PDU session establishment request comprises information indicating that the first category of the first backhaul network is unknowable, the QoS information comprises QoS information of all of the plurality of backhaul networks, and
wherein, in case that the PDU session establishment request comprises information indicating the second category of the second backhaul network used in the control plane, the QoS information comprises QoS information of backhaul networks other than the second backhaul network, among the plurality of backhaul networks.

8. The AMF entity of claim 5, wherein the information indicating the first category comprises information on an accepted QoS flow identifier (QFI) and a rejected QFI, or an indicator for the first backhaul network.

9. A method performed by a session management function (SMF) entity in a wireless communication system, the method comprising:
in case that two or more backhaul networks are used for a protocol data unit (PDU) session, receiving, from an access and mobility management function (AMF) entity, a PDU session establishment request comprising first information on a satellite backhaul category and second information indicating that the two or more backhaul networks are used;
transmitting, to a policy control function (PCF) entity, a session management (SM) policy request comprising the first information and the second information;
receiving, from the PCF entity, quality of service (QoS) information of a plurality of backhaul networks for determining a first backhaul network to be used in a user plane, among the two or more backhaul networks, based on the first information and the second information;
transmitting, to the AMF entity, the QoS information of the plurality of backhaul networks; and
receiving, from the AMF entity, information indicating a first category of the first backhaul network, among the plurality of backhaul networks, based on the QoS information.

10. The method of claim 9, wherein the PDU session establishment request comprises information indicating that the first category of the first backhaul network used in the user plane is unknowable, or information indicating a second category of a second backhaul network used in a control plane.

11. The method of claim 10, wherein, in case that the PDU session establishment request comprises information indicating that the first category of the first backhaul network is unknowable, the QoS information comprises QoS information of all of the plurality of backhaul networks, and
wherein, in case that the PDU session establishment request comprises information indicating the second category of the second backhaul network used in the control plane, the QoS information comprises QoS information of backhaul networks other than the second backhaul network, among the plurality of backhaul networks.

12. The method of claim 9, wherein the information indicating the first category comprises information on an accepted QoS flow identifier (QFI) and a rejected QFI, or an indicator for the first backhaul network.

13. A session management function (SMF) entity in a wireless communication system, the SMF entity comprising:
a transceiver; and
a controller coupled to the transceiver,
wherein the controller is configured to:
in case that two or more backhaul networks are used for a protocol data unit (PDU) session, receive, from an access and mobility management function (AMF) entity, a PDU session establishment request comprising first information on a satellite backhaul category and second information indicating that the two or more backhaul networks are used;
transmit, to a policy control function (PCF) entity, a session management (SM) policy request comprising the first information and the second information;
receive, from the PCF entity, quality of service (QoS) information of a plurality of backhaul networks for determining a first backhaul network to be used in a user plane, among the two or more backhaul networks, based on the first information and the second information;
transmit, to the AMF entity, the QoS information of the plurality of backhaul networks; and
receive, from the AMF entity, information indicating a first category of the first backhaul network, among the plurality of backhaul networks, based on the QoS information.

14. The SMF entity of claim 13, wherein the PDU session establishment request comprises information indicating that the first category of the first backhaul network used in the user plane is unknowable, or information indicating a second category of a second backhaul network used in a control plane.

15. The SMF entity of claim 14, wherein, in case that the PDU session establishment request comprises information indicating that the first category of the first backhaul network is unknowable, the QoS information comprises QoS information of all of the plurality of backhaul networks, and
wherein, in case that the PDU session establishment request comprises information indicating the second category of the second backhaul network used in the control plane, the QoS information comprises QoS information of backhaul networks other than the second backhaul network, among the plurality of backhaul networks.
